(19) United States
(12) Patent Application Publication
(10) Pub. No.: US 2017/0196380 A1
(43) Pub. Date: Jul. 13, 2017

(54) ROOM DIVIDER WITH SHOWER CURTAIN

(71) Applicant: Maureen Patricia Chapman, South Deerfield, MA (US)

(72) Inventor: Maureen Patricia Chapman, South Deerfield, MA (US)

(21) Appl. No.: 15/404,669

(22) Filed: Jan. 12, 2017

Related U.S. Application Data
(60) Provisional application No. 62/278,301, filed on Jan. 13, 2016.

(51) Int. Cl. A47G 5/00; A47K 3/38; E06B 9/24; A47H 13/04; E04B 2/74

(52) U.S. Cl. CPC A47G 5/00; A47H 13/04; E04B 2/7405; E06B 9/24; A47K 3/38

(57) ABSTRACT

A room divider with a shower curtain is provided. The room divider includes a plurality of rigid panels. The plurality of rigid panels may at least include a first panel and a second panel. Each of the rigid panels includes opposing top and bottom edges and opposing side edges. The first panel and the second panel may be connected together at the side edges by at least one hinge. The shower curtain is made of a flexible material and includes opposing upper and lower edges. A plurality of curtain hooks may be attached to the upper edge of the shower curtain. The curtain hooks hang from the top edges of the rigid panels.

### CROSS-REFERENCE TO RELATED APPLICATION

This application claims the benefit of priority of U.S. provisional application No. 62/278,301, filed Jan. 13, 2016, the contents of which are herein incorporated by reference.

### BACKGROUND OF THE INVENTION

The present invention relates to a room divider and, more particularly, to a room divider with a shower curtain.

A room divider is a screen or piece of furniture placed in a way that divides a room into separate areas. Many room dividers include multiple panels attached together by hinges, which may be desirable to use in lieu of a shower curtain. However, most room dividers are not made of a water impermeable material, and may begin to degrade or rot due to the water from the shower.

As can be seen, there is a need for a room divider that is water impermeable to be used as a shower curtain.

### SUMMARY OF THE INVENTION

In one aspect of the present invention, an apparatus comprises: a room divider comprising a plurality of rigid panels each comprising opposing top and bottom edges and opposing side edges, wherein the plurality of rigid panels comprises at least a first rigid panel and a second rigid panel connected at the side edges by at least one hinge; a shower curtain comprising a flexible material having opposing upper and lower edges; and a plurality of curtain hooks secured to the upper edge of the shower curtain and hanging from the top edges of the plurality of rigid panels of the room divider.

In another aspect of the present invention, an apparatus comprises: a room divider comprising a plurality of rigid panels each comprising opposing top and bottom edges and opposing side edges, wherein the plurality of rigid panels comprises at least a first rigid panel and a second rigid panel connected at the side edges by at least one hinge, wherein each of the plurality of panels comprises a plurality of panel hooks secured near the top edge and each of the plurality of panels comprises a curtain rod disposed within the panel hooks; a shower curtain comprising a flexible material having opposing upper and lower edges; and a plurality of curtain hooks secured to the upper edge of the shower curtain and hanging from the curtain rods of the plurality of rigid panels of the room divider.

These and other features, aspects and advantages of the present invention will become better understood with reference to the following drawings, description and claims.

### BRIEF DESCRIPTION OF THE DRAWINGS

FIG. 1 is a front perspective view of an embodiment of the present invention;

FIG. 2 is a rear perspective view of an embodiment of the present invention;

FIG. 3 is a rear exploded view of an embodiment of the present invention;

FIG. 4 is a section view of the present invention taken along line 4-4 in FIG. 2;

FIG. 5 is a front perspective view of an embodiment of the present invention in a folded position;

FIG. 6 is a front perspective view of an embodiment of the present invention;

FIG. 7 is a front perspective view of an embodiment of the present invention;

FIG. 8 is a rear perspective view of an embodiment of the present invention; and

FIG. 9 is a rear exploded detail view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a waterproof shower room divider. The divider increases bathroom design and function by allowing a room divider to be transformed into a more visually appealing shower curtain. The present invention blocks the view of the entire shower and room dividers already come in many shapes, sizes and designs. The waterproof room divider can easily be removed to allow more space for getting in and out of the shower or tub. It can also be used outside for public showers at beach homes to allow for privacy.

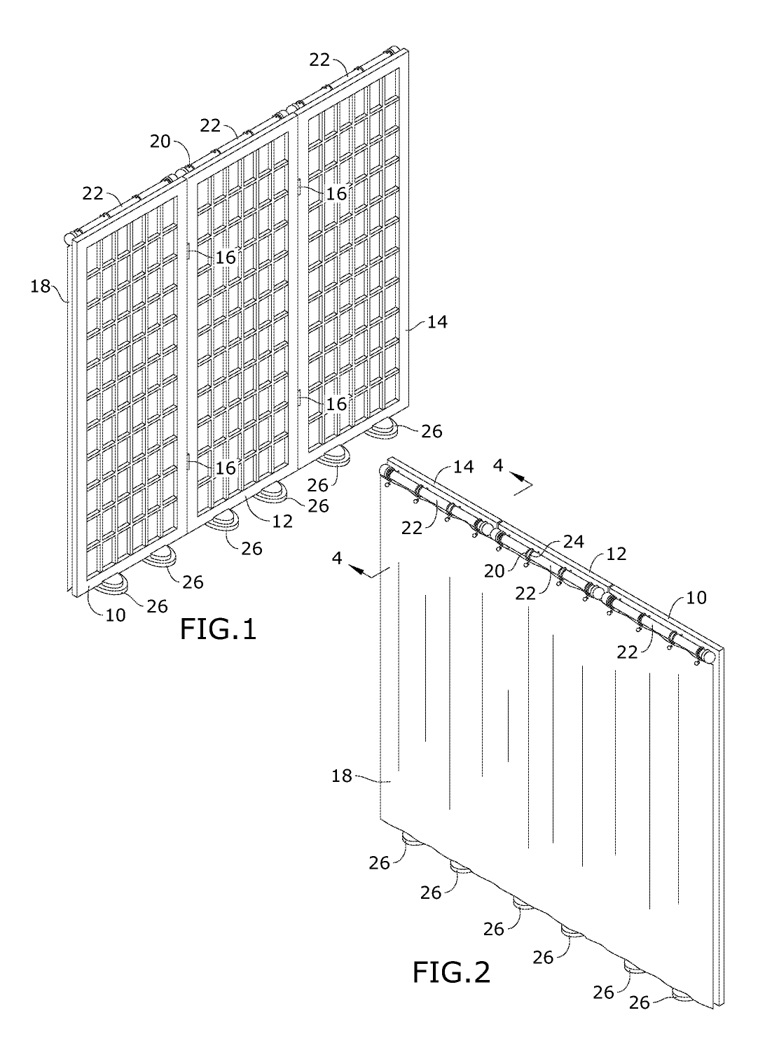

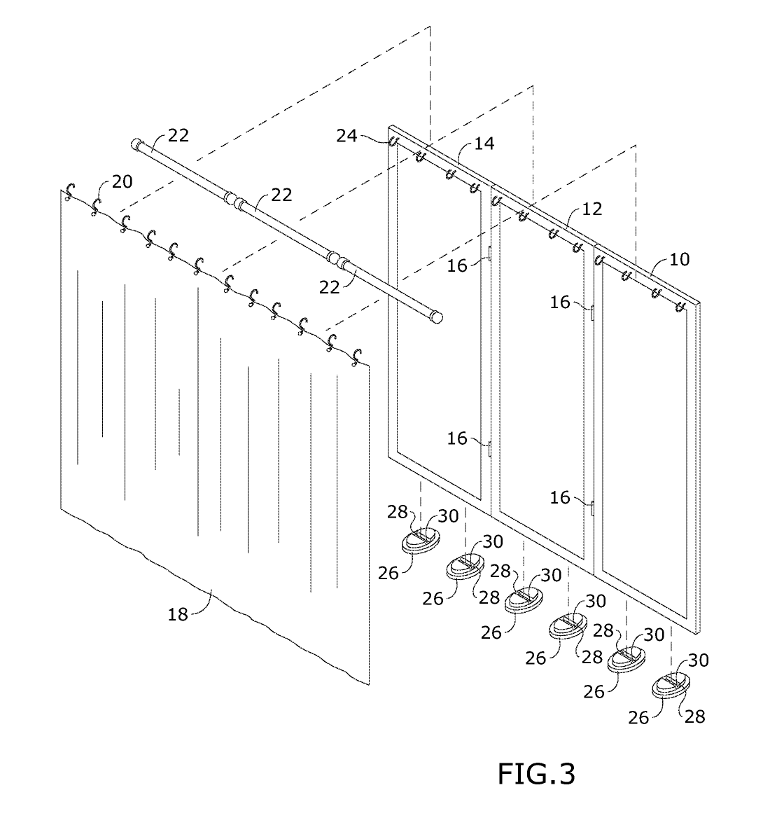

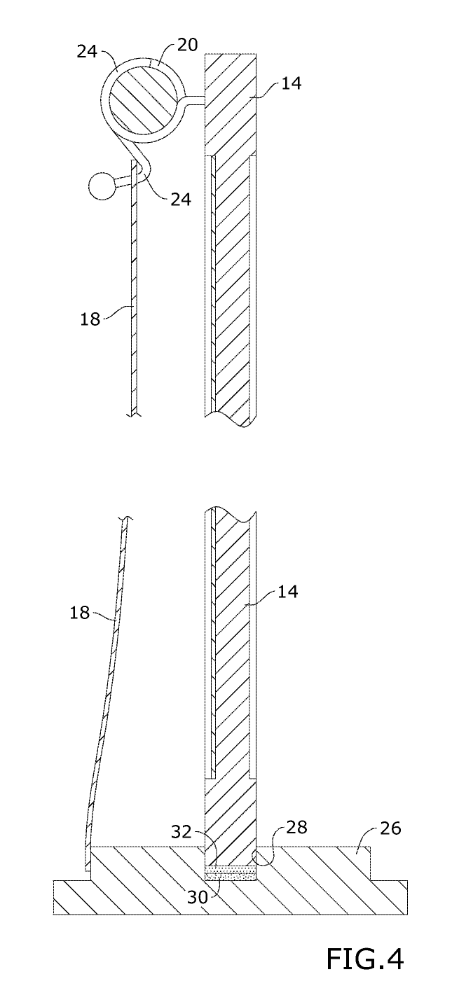

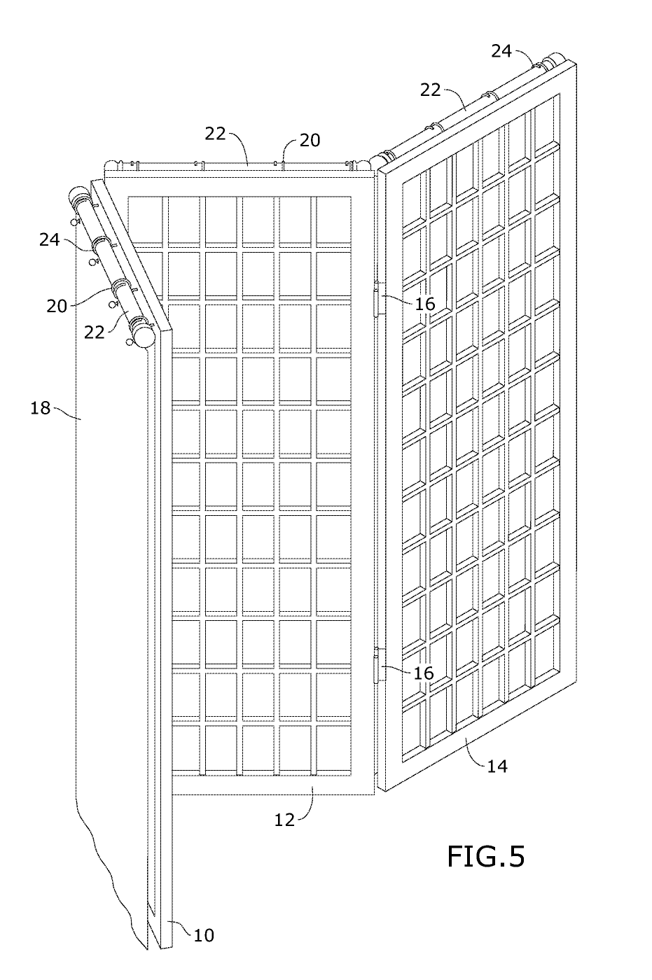

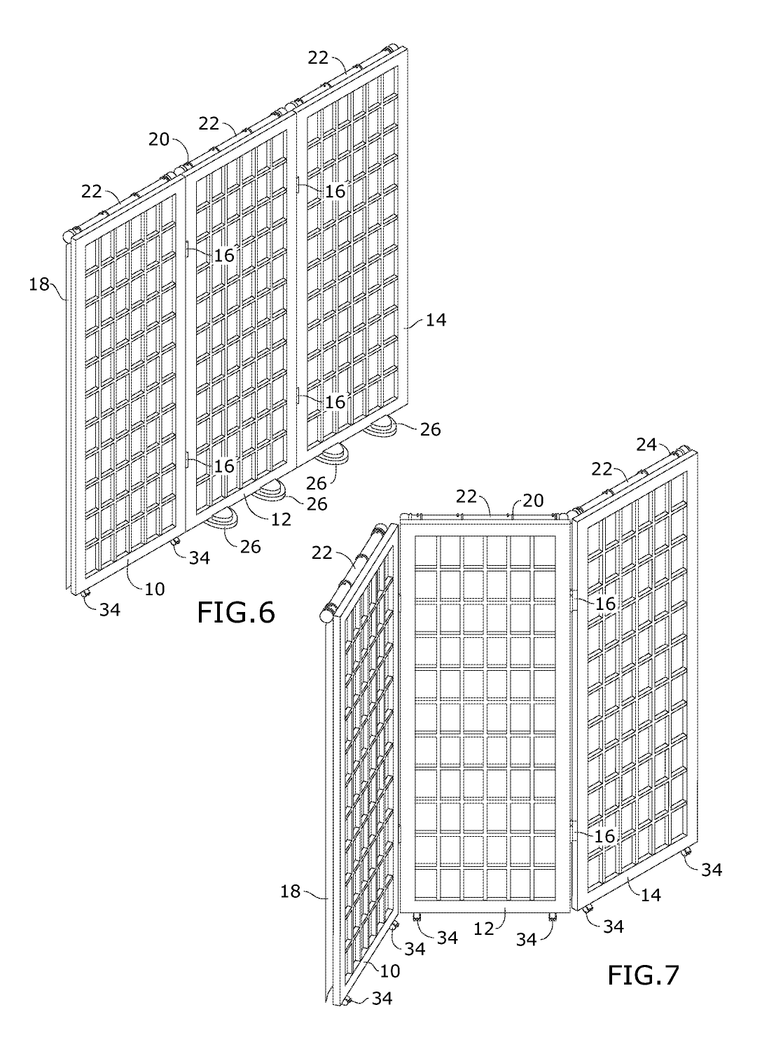

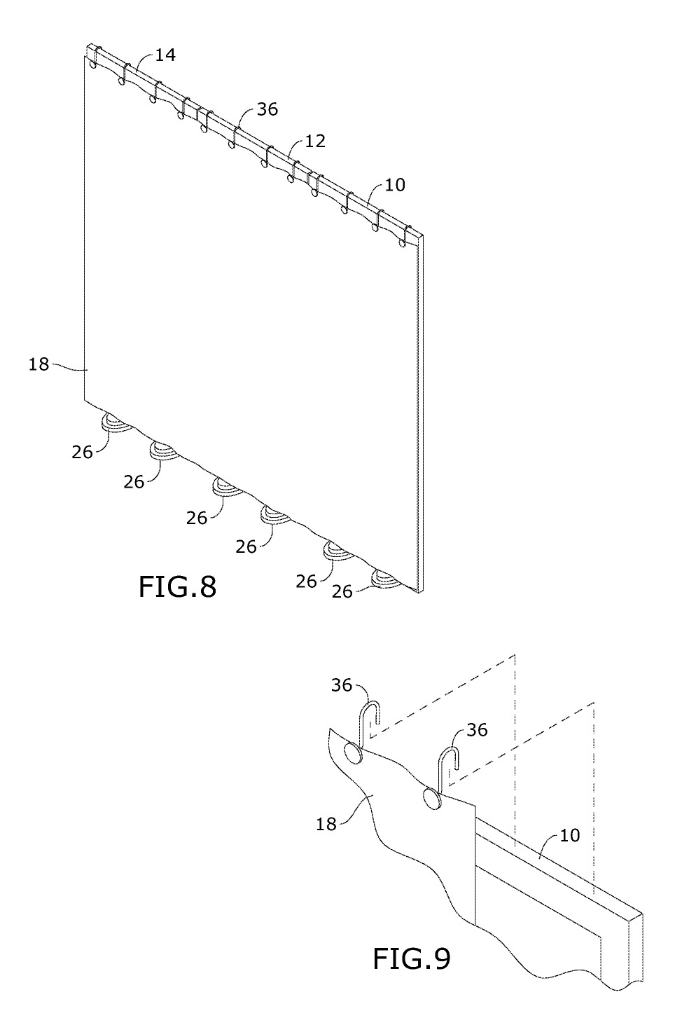

Referring to FIGS. 1 through 9, the present invention includes a room divider with a shower curtain 18. The room divider includes a plurality of rigid panels 10, 12, 14. The plurality of rigid panels 10, 12, 14 may at least include a first panel 10 and a second panel 12. Each of the rigid panels 10, 12, 14 includes opposing top and bottom edges and opposing side edges. The first panel 10 and the second panel 12 may be connected together at the side edges by at least one hinge 16. The shower curtain 18 is made of a flexible material and includes opposing upper and lower edges. A plurality of curtain hooks 20 may be attached to the upper edge of the shower curtain 18. The curtain hooks 20 hang from the top edges of the rigid panels 10, 12, 14.

The shower curtain 18 of the present invention may be made of a fabric material and/or a plastic water resistant material. In certain embodiments, even spaced apertures may be formed through the upper edge of the shower curtain 18. The curtain hooks 20 may include S-shaped hooks having a flat base and a hook portion. The flat bases may be disposed on a first side of the shower curtain 18 and the curtain hooks 20 may run through the apertures. The hook portions may protrude from a second side, opposite the first side. The hook portions may be secured over the top edge of the rigid panels 10, 12, 14.

In certain embodiments, the plurality of rigid panels 10, 12, 14 include the first rigid panel 10, the second rigid panel 12 and a third rigid panel 14. At least one hinge 16, such as two hinges 16, may connect the first rigid panel 10 to the second rigid panel 12 and at least one hinge 16, such as two hinges 16, may connect the second rigid panel 12 to the third rigid panel 14. The rigid panels 10, 12, 14 may be made of a various amount of materials including, but not limited to, wood, fabric, plexiglass, framed cotton canvas, pleated fabric, mirrors or a combination thereof. For example, the panels 10, 12, 14 may include a wooden boarder, wooden crisscrossing frame members and a fabric material disposed therebetween.

In certain embodiments, each the panels 10, 12, 14 may include a plurality of panel hooks 24 secured near the top edge. The plurality of panel hooks 24 may be evenly spaced apart from one another. A curtain rod 22 may rest within each of the plurality of panel hooks 24 of each of the panels 10, 12, 14. The curtain rods 22 may include an elongated cylinder rod. In such embodiments, the plurality of curtain hooks 20 hang from the curtain rods 22.

The present invention may further include a plurality of feet 26 to help support the rigid panels 10, 12, 14 in an upright position. Each foot 26 may include a substantially planar lower surface and an upper surface. The upper surface may include a recess forming a channel 28 sized to receive the bottom edges of the rigid panels 10, 12, 14. The bottom edges of the rigid panels 10, 12, 14 are disposed within the channels 28. Due to the elongated width of the feet 26 and the substantially planar bottom surface, the feet 26 support the rigid panels 10, 12, 14 in a vertical position. To further secure the feet 26 to the rigid panels 10, 12, 14, each of the feet 26 may include a hook and loop connector 30 disposed within the channel 28. The bottom edges of the rigid panels 10, 12, 14 may also include a hook and loop connector 32. The hook and loop connectors 30 of the channels are releasably secured to the hook and loop connectors 32 of the bottom edges of the plurality of rigid panels 10, 12, 14, preventing the feet 26 from easily separating from the rigid panels 10, 12, 14.

In certain embodiments, the present invention includes casters 34. The casters 34 may be secured to one or more of the rigid panels 10, 12, 14. The casters 34 may also be used in conjunction with the feet 26. For example, a plurality of casters 34 may be secured to the bottom edge of the first rigid panel 10. The second rigid panel 12 and the third rigid panel 14 may each be supported by the plurality of feet 26. This allows a user to easily swivel the first rigid panel 10 in order to enter and exit the shower. Further, the first and second panels 10, 12 may include the casters 26 and the third rigid panel 14 may include the feet 26.

Alternate configurations including the casters 26 and the feet 26 may be utilized with the rigid panels 10, 12, 14.

Adding a shower curtain to the shower side of the room divider stops water from spraying onto the floor when showering. The present invention also protects the room divider from getting wet from the water from the shower. Adding the feet to the bottom of the room divider assists with stabilizing (keeping it from tipping over) the room divider. Alternatively, lockable casters may be attached to the bottom. Another way to add stability is a wire attachment with a rubber coating that is part of the room divider and goes over the tub edge. The room divider may include two rows of notches for adjusting the height placement of the wire attachment. Another stabilizer of the room divider could be a clip added to the edge of the room divider with the other components added to the wall or ceiling or shower rod to assist with the stabilization of the room divider for safety.

It should be understood, of course, that the foregoing relates to exemplary embodiments of the invention and that modifications may be made without departing from the spirit and scope of the invention as set forth in the following claims.

What is claimed is:

1. An apparatus comprising:
a room divider comprising a plurality of rigid panels each comprising opposing top and bottom edges and opposing side edges, wherein the plurality of rigid panels comprises at least a first rigid panel and a second rigid panel connected at the side edges by at least one hinge;
a shower curtain comprising a flexible material having opposing upper and lower edges; and
a plurality of curtain hooks secured to the upper edge of the shower curtain and hanging from the top edges of the plurality of rigid panels of the room divider.

2. The apparatus of claim 1, wherein the plurality of rigid panels comprises the first rigid panel, the second rigid panel and a third rigid panel, wherein the at least one hinge comprises a first hinge and a second hinge, wherein the first rigid panel is connected to the second rigid panel by the first hinge and the second rigid panel is connected to the third rigid panel by the second hinge.

3. The apparatus of claim 1, further comprising a plurality of feet each comprising an upper surface comprising a channel, wherein the bottom edges of the plurality of rigid panels are disposed within the channels.

4. The apparatus of claim 3, wherein each of the plurality of feet comprises a hook and loop connector disposed within the channel, wherein the bottom edges of the plurality of rigid panels each comprise a hook and loop connector, wherein the hook and loop connectors of the channels are releasably secured to the hook and loop connectors of the bottom edges of the plurality of rigid panels.

5. The apparatus of claim 1, further comprising a plurality of casters secured to the bottom edges of at least one of the plurality of rigid panels.

6. The apparatus of claim 1, wherein each of the plurality of panels comprise a plurality of panel hooks secured near the top edge and each of the plurality of panels comprise a curtain rod disposed within the panel hooks, wherein the plurality of curtain hooks hang from the curtain rods.

7. The apparatus of claim 1, wherein the shower curtain is formed of a water impermeable material.

8. An apparatus comprising:
a room divider comprising a plurality of rigid panels each comprising opposing top and bottom edges and opposing side edges, wherein the plurality of rigid panels comprises at least a first rigid panel and a second rigid panel connected at the side edges by at least one hinge, wherein each of the plurality of panels comprises a plurality of panel hooks secured near the top edge and each of the plurality of panels comprises a curtain rod disposed within the panel hooks;
a shower curtain comprising a flexible material having opposing upper and lower edges; and
a plurality of curtain hooks secured to the upper edge of the shower curtain and hanging from the curtain rods of the plurality of rigid panels of the room divider.

9. The apparatus of claim 8, wherein the plurality of rigid panels comprises the first rigid panel, the second rigid panel and a third rigid panel, wherein the at least one hinge comprises a first hinge and a second hinge, wherein the first rigid panel is connected to the second rigid panel by the first hinge and the second rigid panel is connected to the third rigid panel by the second hinge.

10. The apparatus of claim 9, further comprising a plurality of feet each comprising an upper surface comprising a channel, wherein the bottom edges of the plurality of rigid panels are disposed within the channels.
